(19) United States
(12) Patent Application Publication
(10) Pub. No.: US 2026/0066585 A1
(43) Pub. Date: Mar. 5, 2026

(54) ADAPTER FOR CONNECTING CABLES AND ARRANGEMENT

(71) Applicant: Weidmüller Interface GmbH & Co. KG, Detmold (DE)

(72) Inventors: Simon SEEREINER, Bielefeld (DE); Benedikt STEUBE, Löhne (DE); Ralf TILLMANNS, Kalbe (Milde) (DE)

(21) Appl. No.: 19/316,245

(22) Filed: Sep. 2, 2025

(30) Foreign Application Priority Data
Sep. 3, 2024 (DE) 10 2024 125 141.7

(51) Int. Cl. H01R 13/6473; H01R 12/71

(52) U.S. Cl. CPC H01R 13/6473; H01R 12/716

(57) ABSTRACT

An adapter for cables includes at least a printed circuit board, a plug connector, and a connection device. The plug connector has at least two first plug contacts for plugging together with at least two mating plug contacts of a mating plug connector, to which first conductors of a first cable having a first diameter are connected. The connection device has at least two connections for connecting second conductors of a second cable. The second conductors have a second diameter that differs from the first diameter. The plug contacts are electrically conductively connected to the conductor connections via the printed circuit board so that data and power can be transmitted between the first and the second cable.

### BACKGROUND

The present invention relates to an adapter for connecting cables, and an arrangement with the adapter and two corresponding cables.

Single-Pair Ethernet advantageously enables data transmission via only two conductors of a cable. In Single-Pair Ethernet applications, the problem arises in various applications that only relatively thick cables with conductors of relatively large diameter are available at the point of use for data transmission by means of Single-Pair Ethernet, or that conductors of relatively large diameter have to be used for data transmission over longer distances. These diameters are often too large to be rationally used consistently in standard switch cabinets.

There is therefore a need for a device that is capable of transmitting power and data from a cable with conductors of a first diameter to a cable with conductors of a different diameter.

### SUMMARY OF THE INVENTION

Accordingly, it is an object of the present disclosure to provide an adapter and arrangement for connecting cables. The adapter includes at least a printed circuit board, a plug connector, and an adapter. The plug connector includes at least two first plug contacts for plugging together with at least two mating plug contacts of a mating plug connector to which first conductors of a first cable having a first diameter are connected. Preferably the plug connector is affixed to the printed circuit board. The connection device includes at least two connections for connecting second conductors of a second cable, wherein the second conductors have a second diameter that differs from the first diameter. They plug contacts are electrically conductively connected to the conductor connections to transmit power and data between the first and the second cable.

In one embodiment, the printed circuit board, the plug connector and the connection device form a structural unit.

In another embodiment, the printed circuit board has a metallic layer with conducting tracks and optionally further components.

The present invention allows cables with different diameters to be used in a simple and advantageous manner. For example, the first cable can be one with conductors of smaller diameter, as used in a commercially available switch cabinet, in order to save space. At the same time, the data can be transmitted by the adapter to the second cable, which may be of a cable type that is already available at the place of use, and/or may be configured as a cable with relatively large conductor diameters, e.g. for data transmission over longer distances.

In a preferred embodiment, the adapter is an adapter for connecting Single-Pair Ethernet cables and the data can be transmitted via a Single-Pair Ethernet communication method. The cables are thus configured as Single-Pair Ethernet cables, i.e. as cables that are suitable for this application. Data transmission can preferably take place in both directions, i.e. from the first cable to the second and/or vice versa. The conductors of the cables can be configured as single cores or as core bundles made of metal with good electrical conductivity.

Preferably, the plug connector has precisely two first plug contacts and the connection device has precisely two conductor connections, which is particularly advantageous for a Single-Pair Ethernet data transmission/application.

According to a further embodiment, the printed circuit board may have an impedance-matching circuit for impedance matching, or for matching the cable impedances, which may have at least one capacitor or consist of one capacitor. This improves data transmission, in particular by improving the achievable signal quality after its transmission from one of the cables to the other. The at least one capacitor may substantially or exclusively have air as a dielectric and thus be particularly easy and inexpensive to manufacture.

According to yet another embodiment, the printed circuit board has one or more metal layers. In a variant, the at least one capacitor furthermore has electrodes or has only electrodes formed from or consisting of only one or two of the metal layers of the printed circuit board, which simplifies manufacture of the adapter even further and makes possible a space-saving design without further discrete components except for the plug connector and the connections of the connection side.

In a further embodiment still, all electrodes of the at least one capacitor are preferably each configured in the same metal layer of the printed circuit board, which reduces the number of masks required for manufacture and enables the printed circuit board to be manufactured as single-sided, or at least only as a two/double-sided printed circuit board. This is simple, cost-effective, and saves precious metal compared to the frequently used four-layer printed circuit boards, which may be necessary to use if the number of discrete components becomes too large. The base material can be FR4, but a printed circuit board optimised for radio frequencies, for example one made of ceramic, can also be used. In the at least one metal layer on the printed circuit board there is configured one metal wire per connection to be connected, which can thus also form or include the capacitors. The area surrounding the metal conductors can be grounded in order to shield the signal.

In yet another embodiment, the at least one capacitor can alternatively or in addition have in each case at least two of the capacitors connected in parallel and/or in series per wire, wherein each capacitor can be activated individually. This increases the flexibility of the impedance matching and in addition enables the adapter to be used over a wider range of signal frequencies due to the adjustability of the capacitance achieved in this way, which must be precisely selected as of the radio frequency range. The impedance matching can be set to 50-ohm or 100-ohm impedances, for example.

In a particularly preferred variant, the printed circuit board can be arranged in a housing. This housing can then optionally have a first housing part and a second housing part, which can be fastened to each another.

The two conductor connections can each be configured as spring or screw terminals, in particular as direct plug-in terminals. The direct plug-in terminals may have a pressure spring that is pre-latched in an open state for inserting the conductor with a retaining spring or the like. The pressure spring is released from its latched state when the conductor end is inserted and then presses the conductor in a contacting member against a respective busbar, which may be connected to a corresponding conducting track of the printed circuit board.

The housing may furthermore have a third housing part that is placed on the second housing part and the second cable, which is retained by a screw. The printed circuit board may be completely enclosed by the housing, whether in this or another manner, wherein a separate removability of the third housing part makes it particularly easy to reach the terminal without having to disassemble the entire device. After removing the third housing part, a mechanism of the terminal, for example the screws or spring-loaded terminal connections, can preferably be accessed in order to release the second cable from the adapter.

In one variant, the housing has a mounting device such as a spring-loaded fastening foot, by which the adapter can be fastened on a support rail.

The housing can be made of an insulating material or a (conductive) metal.

Optionally, it can be envisaged that cable sheaths of the two cables are conductively connected via the adapter, in particular the printed circuit board. The cable sheaths can also be conductively connected to each other via a housing that is preferably metallic, which has the advantage of providing additional shielding.

A cable sheath can also be configured on the first and/or second cable, wherein a corresponding shield potential can be transmitted by a transmission device to the printed circuit board and from there to a cable sheath of the first cable and/or the other cable. This serves to shield the signal and reduces the effect of noise or crosstalk. The transmission device may have a metal clip clamping onto the second cable with clamping wings which may be connected to a busbar via which the shield potential can be transmitted to the printed circuit board, the first cable and/or the support rail. For example, the metal clip and/or the printed circuit board may be connected to the busbar by a screw.

The first diameter is preferably smaller than the second diameter. Even more preferably, the conductors of the first cable can alternatively be configured in accordance with ASTM Standard B 258, or ASTM B 258:2018, corresponding to AWG 22, 23, 24, 25 or 26, particularly preferably corresponding to AWG 22. At the same time, the conductors of the second cable are configured in accordance with the same standard corresponding to AWG 18, 19, or 20, particularly preferably corresponding to AWG 18. In the most preferred variant, Single-Pair Ethernet cables with AWG 18 can thus be connected to Single-Pair Ethernet cables with AWG 22 by means of the adapter. The second cable may have a length of 100m to 2000m, in particular from 500m to 1000m.

The second cable can be longer than the first cable and/or the second diameter can be larger than the first diameter. For example. the first cable can be configured as an AWG 22 cable and the second cable can be configured as an AWG 18 cable. Thanks to the larger diameter, data can also be transmitted over longer distances, while at the same time enabling a switch box for further data processing to be configured in a particularly space-saving manner.

### BRIEF DESCRIPTION OF THE DRAWINGS

The present invention is explained in greater detail hereafter using a number of drawings. In the drawings:

FIGS. 1a and 1b are side and top views, respectively, of an adapter according to the present disclosure;

FIG. 1c is a schematic view of a cutout from FIGS. 1a and 1b;

FIGS. 2a and 2b are plan and lateral views, respectively, of the adapter of FIG. 1a with a housing;

FIG. 2c is a partial sectional view of the adapter from FIGS. 2a and 2b;

FIGS. 3a and 3b are side and plan views, respectively, of a further embodiment of an adapter according to the present disclosure;

FIGS. 4a and 4b are side and plan views, respectively, of the adapter of FIGS. 3a and 3b with a housing;

FIG. 4c is a partial sectional view of the adapter from FIGS. 4a and 4b;

FIGS. 5a and 5b are side and plan views, respectively, of a further embodiment of an adapter according to the present disclosure; and FIG. 5c is a partial sectional view of the adapter from FIGS. 5a and 5b.

### DETAILED DESCRIPTION

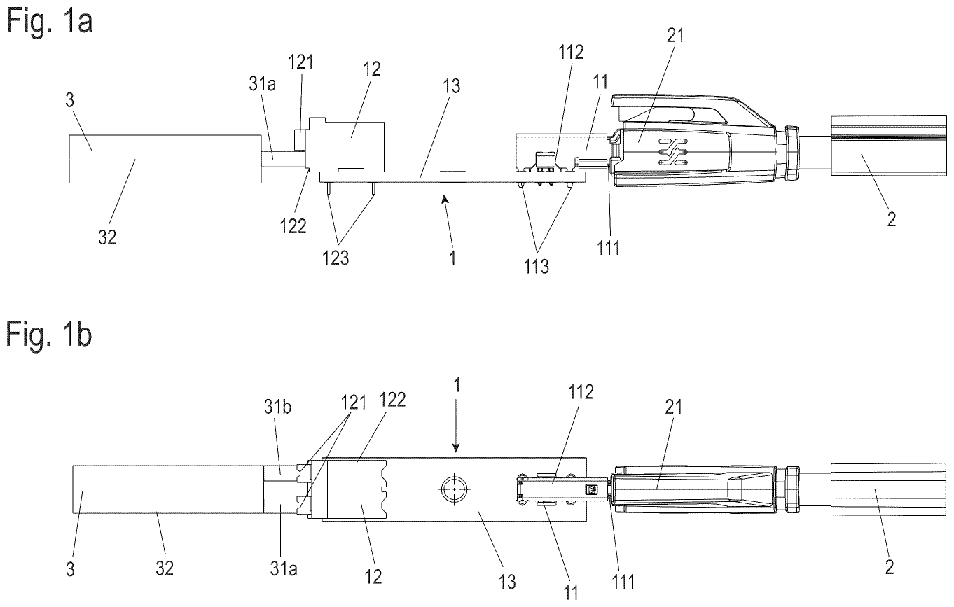

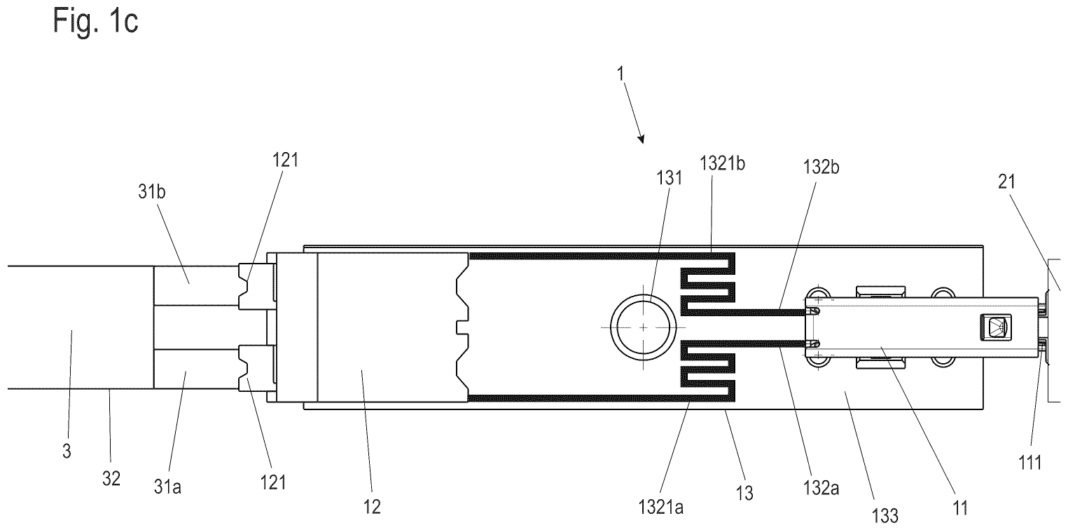

FIG. 1 shows a lateral view of an adapter 1 according to the invention for connecting two cables, which is designed to connect cables having conductors having different diameters.

The adapter 1 has a printed circuit board 13 on which there is configured—at the edge here—a plug connector 11, which includes at least two first connections in the form of precisely two plug contacts 111. The first plug contacts 111 are configured for plugging together with at least two mating plug contacts (not depicted here) of a mating plug connector 21. The mating plug contacts are directly or indirectly connected, at their side facing away from the plugging face, to two conductors of a first cable 2. The two conductors have a first diameter.

The adapter furthermore has a connection side 12 which can be designed for the direct connection of conductors 31a, 31b of a further cable. The connection side 12 can include a connection device 122 which, here, has precisely two conductor connections 121. The two conductor connections 121 can each be configured as spring or screw terminals, in particular as direct plug-in terminals. The conductors 31a, 31b of the second cable 3 have a second diameter. The first diameter differs from the second diameter, preferably by being smaller than the second diameter. In the depicted variant, both the first cable 2 and the second cable 3 are configured as Single-Pair Ethernet cables, i.e. as cables via which power and data are transmitted by means of a Single-Pair Ethernet protocol. The cables can each have a cable sheath.

It is preferable that the printed circuit board 13, the plug connector 11 and the connection device 122 form a structural unit. For this purpose, the elements 11, 122 can be fastened on the printed circuit board 13.

In the depicted embodiment, the connections 121 of the connection device 22 are configured as direct-plug-in pressure spring-loaded terminal connections in which the conductors 31a and 31b are fixed in a clamping manner. Other connection devices can also be used in connection technologies, such as screw connections. The second cable 3 also has a jacket 32 in which conductors 31a, 31b are embedded, with the conductors 31a, 31b being able to be twisted together.

Both the conductor connections 121 and the plug connector 11 can each be configured as through-hole components, with respect to their printed circuit board connection side, and soldered to the printed circuit board in this way. Alternative connections are conceivable, such as “surface-mount” fixings.

In this embodiment, the conductors of the first cable 2 can be configured, by way of example, in accordance with ASTM B 258:2018 corresponding to AWG 22, and the conductors of the second cable 3 can be configured corresponding to AWG 18. However, the conductors of the first cable 2 can alternatively also be configured in accordance with ASTM Standard B 258 corresponding to AWG 22, 23, 24, 25 or 26. The conductors of the second cable 3 can be configured in accordance with ASTM Standard B 258 corresponding to AWG 18, 19 or 20.

The plug contacts 111 of the plug connector 11 can also be soldered to the printed circuit board 13 on their side facing away from the plugging face side. There, they can be electrically conductively connected to one of the conductor connections 121 respectively, in particular via a metal layer, so that data can be transmitted between the first cable 2 and the second cable 3 via a Single-Pair Ethernet communication method.

FIG. 1b shows a plan view of the adapter 1 from FIG. 1a. The mating plug connector 21 can optionally have a latching device by which it can be fixed in a latching manner to the plug connector 11 so that it can be removed from the plug connector 11 and thus from the adapter only when a release element is actuated.

FIG. 1c shows a schematic view of the printed circuit board 13 from FIG. 1b.

The printed circuit board can have two conducting tracks 132a, 132b by which the data, and also power, can be transmitted between the two cables 2, 3, which here is preferably via a Single-Pair Ethernet standard. The conducting tracks 132a, 132b can be configured in the at least one metal layer 133. An impedance-matching circuit 1321 can be provided, which can have a first capacitor 1321a, 1321b, the electrodes of which are each formed from sections of the metal layer 133 and between which air can be present as a dielectric.

Preferably, a remaining portion of the metal layer 133 may be grounded in order to prevent noise and crosstalk between the conducting tracks 132a, 132b. Data transmission by Single-Pair Ethernet optionally utilizes frequency channels around 600 MHz.

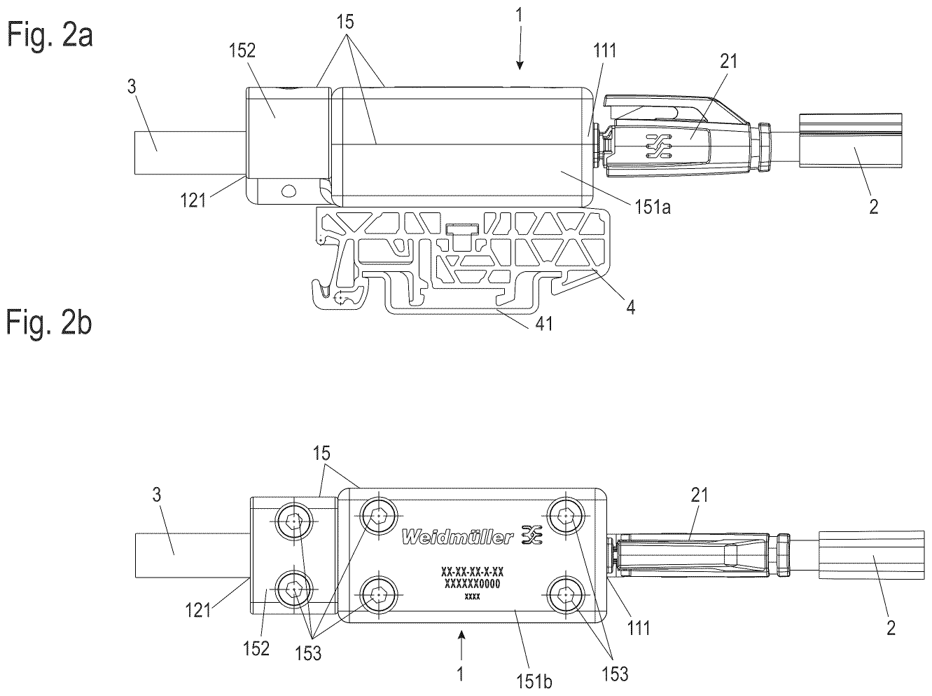

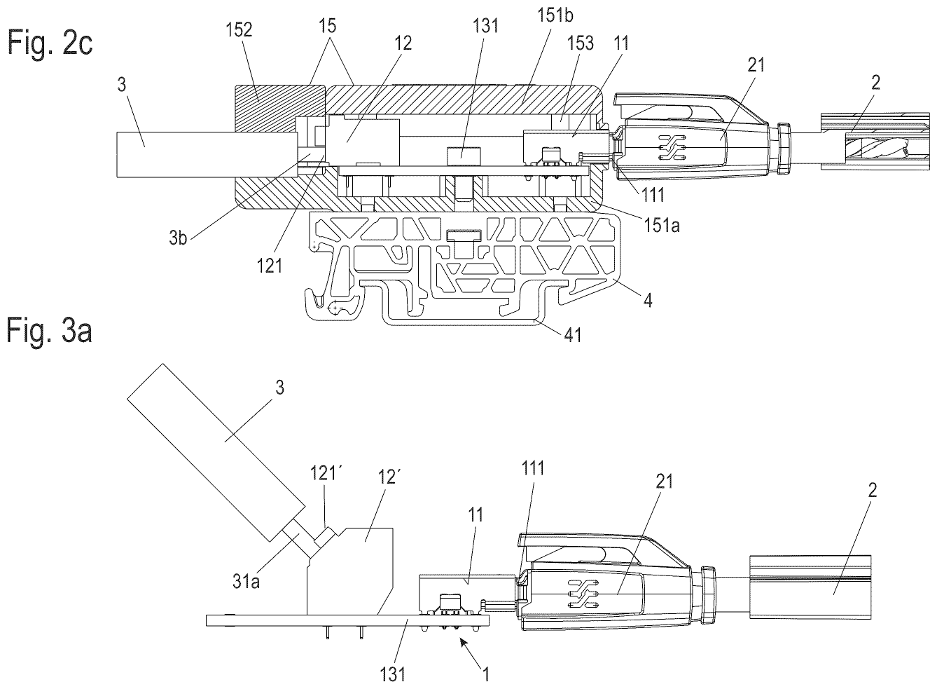

FIG. 2a shows the adapter 1 from FIG. 1a to 1c equipped with a housing 15, which includes a first housing part 151a below the printed circuit board 13 from FIG. 1a, on which there can be configured a fastening foot 4 which is clamped onto a support rail 41 as a mounting base in a switch cabinet.

The housing 15 can have a second housing part 151b which can be placed onto the first housing part 151a. It can be seen in FIG. 2b that the second housing part 151b can, in particular, be fixed to the first housing part 151a by fasteners such as one or more screws 153.

Optionally, the housing 15 can have a third housing part 152 which can be placed onto a section of the printed circuit board 15 so that it covers the connection device 122 and the end of the jacket or insulation 32 of the second cable 3. The printed circuit board 13 can thus be arranged as completely as possible within the housing 15. This can be clearly seen in the cross-section of FIG. 2a in FIG. 2c. The third housing part 152 can also be appropriately fixed to the second housing part 151b with one or more fastener, such as one or more screws 153, as depicted in FIG. 2a.

The printed circuit board 13 can also be fixed to the housing, in this case to the first housing part 151a, by a fastener 131, which in this case includes one or more screws.

The third housing part 152 can optionally be removable from the adapter 1, for example in order to be able to actuate the connection device 122 used here and/or in order to connect the conductors 31a, 31b of the second cable 3.

The cables 2, 3 are aligned collinearly in the variant depicted in FIGS. 1 and 2, but they can also be aligned at an angle to one another and connected to the adapter.

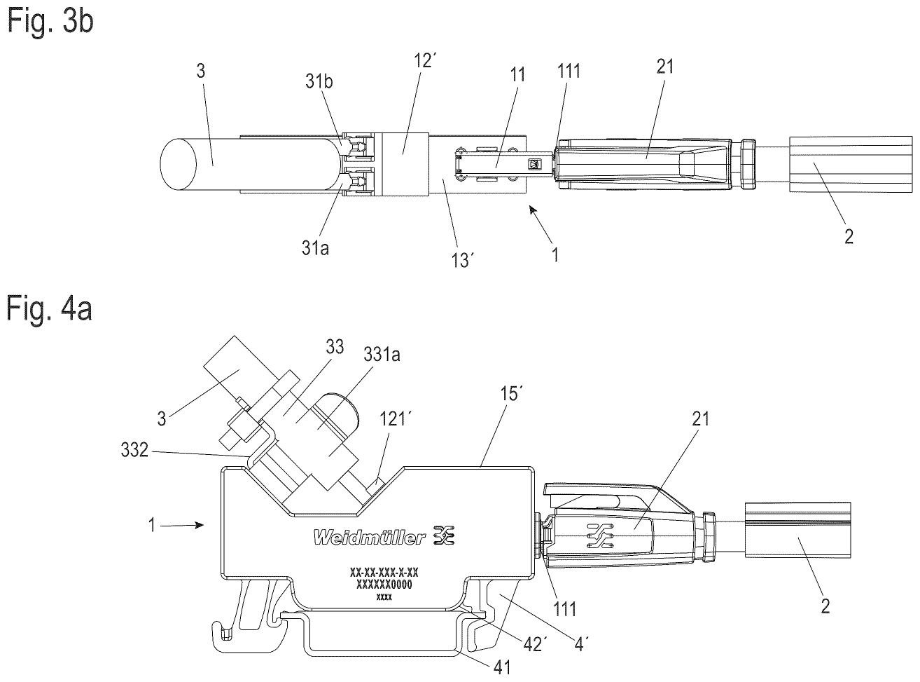

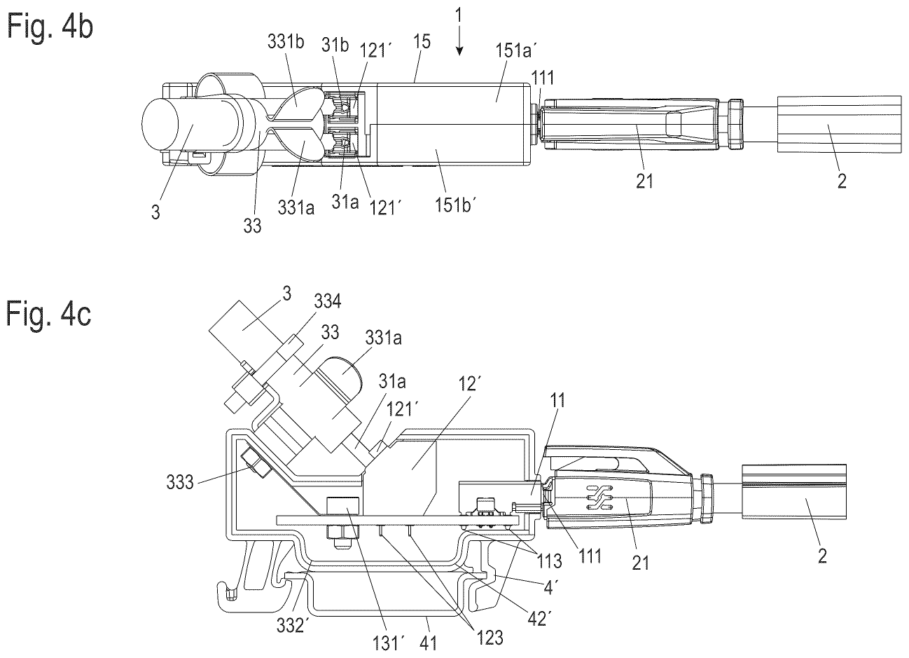

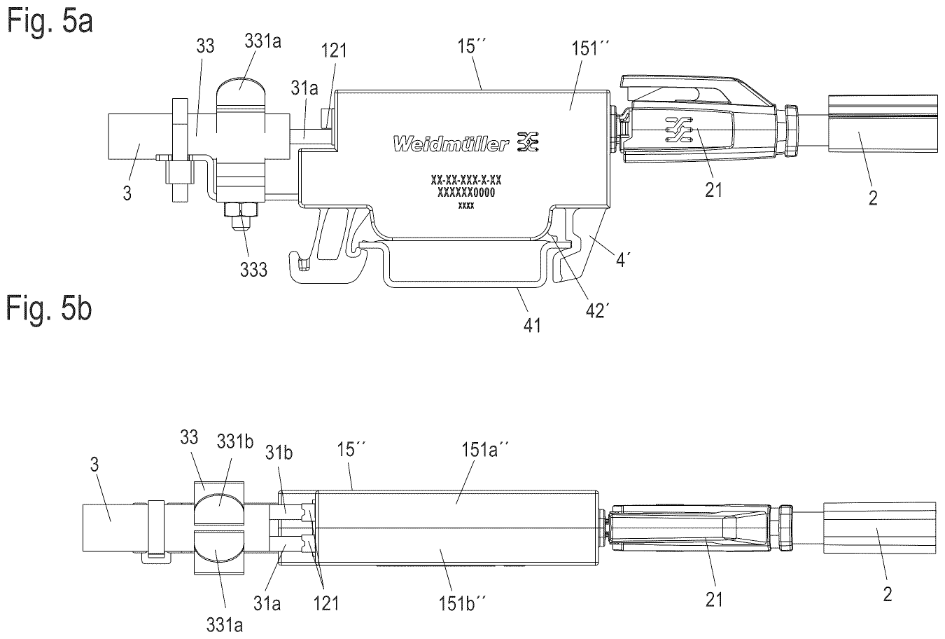

FIG. 3a shows a lateral view and FIG. 4b shows a plan view of an adapter 1 according to a corresponding further embodiment of the present invention. In contrast to FIGS. 1 and 2, the conductor connections 121 are aligned here in such a way that the connected conductors do not run parallel, but rather at an angle, to the printed circuit board 13. Otherwise, the structure of the adapter can correspond to that of FIGS. 1 and 2.

FIGS. 4a, 4b and 4c show views of the adapter 1 of FIG. 3a analogous to FIGS. 2a, 2b and 2c.

There are differences to FIG. 2, principally in that no third housing part 152 is used and two housing parts 151a′, 151b′ of an alternative housing 15′ are attached to the printed circuit board 13′ and connected to one another in a latching manner from two sides from the viewpoint of the figure instead of from above and below. This is to completely cover the printed circuit board, resulting in part of the connections 121′ being visible.

A fastening device 4′ in the form of a latching and/or clamping foot, which is firmly latched to a support rail 41, is also configured on the housing 15′.

As is shown in FIG. 4c, a device for connecting a cable sheath of the second cable 3 to the adapter 1 can be configured on the second cable 3. This may have a metal clip 33 which can be connected to a cable sheath of the second cable 3. The metal clip 33 can be fixed to the second cable 3 by clamping wings 331a, 331b. The second cable 3 can also be additionally fastened to a rail 333 with a cable tie 334. This rail 3 can be configured as a busbar, against which the cable sheath is also laid and which can be connected to the printed circuit board 13.

A device for connecting a cable sheath of the first cable 2 can also be configured on the first plug connector. The cable sheaths of the two cables can be connected to each other via the adapter, in particular the printed circuit board 13.

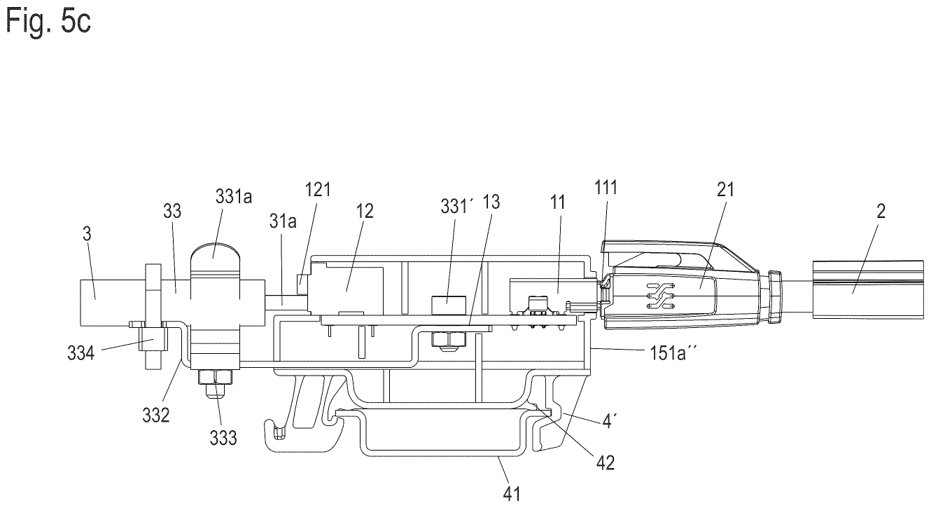

FIG. 5a shows a further embodiment of the present invention, which includes a combination of the embodiments from FIGS. 1a and 3a.

The adapter 1 here has the printed circuit board 13 of the first embodiment from FIG. 1a and a housing 15″ that roughly corresponds to the housing 15′ of the second embodiment. However, the conductor connections 1121 here allow the conductors to be connected parallel to the printed circuit board 13. The two cables 2 and 3 can thus run parallel to each other.

What is claimed is:

1. An adapter for connecting cables, which comprises at least:
a. a printed circuit board;
b. a plug connector having at least two first plug contacts for plugging together with at least two mating plug contacts of a mating plug connector, first conductors of a first cable having a first diameter being connected to the mating plug contacts;
c. a connection device with at least two conductor connections for connecting second conductors of a second cable, the second conductors having a second diameter that differs from the first diameter, wherein the plug contacts are connected to the conductor connections via the printed circuit board to transmit power and data between the first and the second cable.

2. The adapter according to claim 1, wherein the data is transmitted between the first and the second cable via a Single-Pair Ethernet communication method.

3. The adapter according to claim 1, wherein the plug connector has precisely two first plug contacts and the connection device has precisely two conductor connections.

4. The adapter according to claim 1, wherein the printed circuit board, the plug connector and the connection device form a structural unit.

5. The adapter according to claim 1, wherein the printed circuit board has an impedance-matching circuit for impedance matching between the first conductors and the second conductors.

6. The adapter according to claim 1, wherein the first diameter of the conductors of the first cable is smaller than the second diameter of the conductors of the second cable.

7. The adapter according to claim 5, wherein the impedance-matching circuit includes at least one capacitor.

8. The adapter according to claim 7, wherein the at least one capacitor substantially or exclusively has air as the dielectric.

9. The adapter according to claim 7, wherein the printed circuit board has one or more metal layers and the at least one capacitor has electrodes formed from metal layers of the printed circuit board.

10. The adapter according to claim 9, wherein the electrodes of the at least one capacitor are each configured in the same metal layer of the printed circuit board.

11. The adapter according to claim 7, wherein the impedance-matching circuit has in each case at least two of the capacitors connected one of in parallel, in series, or both, wherein each capacitor can be activated individually.

12. The adapter according to claim 1, wherein the printed circuit board is arranged in a housing.

13. The adapter according to claim 12, wherein the housing has at least a first housing part and a second housing part.

14. The adapter according to claim 1, wherein the two conductor connections are each configured as direct plug-in terminals being one of spring and screw terminals.

15. The adapter according to claim 12, wherein the housing has a mounting device being a fastening foot by which the adapter can be fastened on a support rail.

16. The adapter according to claim 12, wherein the two cables include cable sheaths conductively connected via the adapter by one of the printed circuit board and the housings.

17. The adapter according to claim 1, wherein the conductors of the first cable are configured in accordance with ASTM Standard B 258 corresponding to AWG 22, 23, 24, 25 or 26, and in that the conductors of the second cable are configured in accordance with ASTM Standard B 258 corresponding to AWG 18, 19 or 20.

18. The adapter according to claim 1, wherein the second cable has a length of 500m to 1000m.

19. An arrangement consisting of an adapter according to claim 1 and of the first cable and the second cable with the mating plug connector.
